(19) United States
(12) Patent Application Publication
(10) Pub. No.: US 2024/0064855 A1
(43) Pub. Date: Feb. 22, 2024

(54) Sidelink Discontinuous Reception at a User Equipment

(71) Applicant: Apple Inc., Cupertino, CA (US)

(72) Inventors: Zhibin WU, Los Altos, CA (US); Fangli XU, Beijing (CN); Chunxuan YE, San Diego, CA (US); Dawei ZHANG, Saratoga, CA (US); Haijing HU, Los Gatos, CA (US); Yuqin CHEN, Beijing (CN)

(21) Appl. No.: 18/260,393

(22) PCT Filed: Jan. 14, 2021
(86) PCT No.: PCT/CN2021/071901

§ 371 Date: Jul. 5, 2023

(51) Int. Cl. H04W 76/28; H04W 72/25; H04L 1/1812

(52) U.S. Cl. CPC H04W 76/28; H04W 72/25; H04L 1/1812

(57) ABSTRACT

A user equipment (UE) is configured to operate in a sidelink discontinuous reception (DRX) cycle. The UE establishes a sidelink with a further UE, configures a sidelink discontinuous reception (DRX) cycle, receives first sidelink control information (SCI) and first data at a first time during the sidelink DRX cycle and receives second SCI at a second time during the sidelink DRX cycle.

### TECHNICAL FIELD

This application relates generally to wireless communication, and in particular relates to Sidelink Discontinuous Reception at a User Equipment.

### BACKGROUND

A user equipment (UE) may be configured with multiple communication links. For example, the UE may receive a signal from a cell of a network over a downlink and may transmit a signal to the cell over an uplink. The UE may also be configured to communicate with a further UE via a sidelink. The term sidelink refers to a device-to-device (D2D) communication link. Thus, the sidelink facilitates communication between the UE and the further UE without the use of the cell.

The UE may also be configured with a sidelink discontinuous reception cycle (DRX) cycle. The DRX cycle may refer to a power saving mechanism that includes an active mode of data exchange processing and a sleep mode of inactivity. From the perspective of the UE, implementing a sidelink DRX cycle may include managing one or more timers. The status of the DRX timers and other sidelink DRX parameters may influence various aspects of UE behavior with regard to data exchange processing.

### SUMMARY

Some exemplary embodiments are related to a processor of a user equipment (UE) configured to perform operations. The operations include establishing a sidelink with a further UE, configuring a sidelink discontinuous reception (DRX) cycle, receiving first sidelink control information (SCI) and first data at a first time during the sidelink DRX cycle and receiving second SCI at a second time during the sidelink DRX cycle.

Other exemplary embodiments are related to user equipment (UE) including a transceiver configured to communicate with a sidelink and a processor communicatively coupled to the transceiver and configured to perform operations. The operations include configuring a sidelink discontinuous reception (DRX) cycle, utilizing an active mode of data exchange processing during an onDuration of the sidelink DRX cycle and utilizing a sleep mode of inactivity outside of the onDuration of the sidelink DRX cycle.

### BRIEF DESCRIPTION OF THE DRAWINGS

FIG. 1 shows an exemplary network arrangement according to various exemplary embodiments.

FIG. 2 shows an exemplary user equipment (UE) according to various exemplary embodiments.

FIG. 3 shows a timeline that represents UE activity according to various exemplary embodiments.

FIG. 4 shows a timeline that represents UE activity according to various exemplary embodiments.

FIG. 5 shows a timeline that represents sidelink activity according to various exemplary embodiments.

FIG. 6 shows a timeline that represents UE activity according to various exemplary embodiments.

### DETAILED DESCRIPTION

The exemplary embodiments may be further understood with reference to the following description and the related appended drawings, wherein like elements are provided with the same reference numerals. The exemplary embodiments relate to implementing a sidelink discontinuous reception (DRX) cycle.

The exemplary embodiments are described with regard to a UE. However, reference to a UE is merely provided for illustrative purposes. The exemplary embodiments may be utilized with any electronic component that may establish a connection to a network and is configured with the hardware, software, and/or firmware to exchange information and data with the network. Therefore, the UE as described herein is used to represent any electronic component.

The term “sidelink” generally refers to a communication link between the UE and a further UE. The sidelink provides direct device-to-device (D2D) communication where information and/or data exchanged between the UE and the further UE via the sidelink does not go through a cell. In some configurations, a single sidelink provides bidirectional communication between the UE and the further UE. In other configurations, a single sidelink provides unidirectional communication between the UE and the further UE. The exemplary embodiments may apply to either a bidirectional or unidirectional sidelink.

Sidelink communications are supported by long term evolution (LTE) and fifth generation (5G) new radio (NR) standards. In some configurations, the network may provide information to the UE that indicates how a sidelink is to be established, maintained and/or utilized. Thus, while the information and/or data exchanged over the sidelink may not traverse a cell, the UE and the network may exchange information associated with the sidelink. In other configurations, a sidelink is not under the control of the network. In either configuration, the UE and the further UE may still perform synchronization procedures, discovery procedures and exchange control information corresponding to the sidelink.

In some configurations, the sidelink may be a radio relay link. For example, a UE-to-Network relay may include a remote UE, a relay UE and a cell. To facilitate communication between the remote UE and the network in a UE-to-Network relay, the cell may exchange signals with the relay UE via an uplink and/or downlink and the relay UE may exchange signals with the remote UE via a sidelink. Thus, the remote UE may access network services via the relay UE. In another example, a UE-to-UE relay may include a first remote UE, a relay UE and a second remote UE. To facilitate communication between the first remote UE and the second remote UE, the first remote UE may exchange signals with the relay UE via a first sidelink and the second remote UE may exchange signals with the relay UE via a second sidelink. Thus, in a UE-to-UE relay the first remote UE may communicate with the second remote UE via the relay UE. However, the intended purpose of the sidelink and the manner in which it is utilized is beyond the scope of the exemplary embodiments. Instead, the exemplary embodiments are directed towards implementing a sidelink DRX cycle.

Those skilled in the art will understand that a DRX cycle refers to a power saving mechanism that includes an active mode of data exchange processing and a sleep mode of inactivity. The UE may use the active mode of data exchange processing at defined intervals to perform scheduled operations such as performing measurements, transmitting (e.g., requests, measurement reports, data, etc.), and receiving (e.g., control information, reference signals, synchronization signals, data, etc.). Throughout this description, an “onDuration” of the sidelink DRX cycle may refer to a time period during which the UE may be scheduled to receive control channel information. During the onDuration, the UE may perform operations that enable the UE to receive information and/or data transmitted to the UE over the sidelink. When the onDuration is not scheduled, the UE may have an opportunity to utilize the sleep mode of inactivity and conserve power.

The sidelink DRX cycle may have a duration (N) expressed in milliseconds (ms) or any other appropriate unit of time. To provide an example of a DRX cycle, at a time 0, there may be a onDuration during which the active mode of processing may be used. Subsequently, upon the conclusion of the onDuration, the UE has an opportunity to utilize the sleep mode of inactivity until time N. At time N, there may be another DRX cycle that includes the onDuration and an opportunity to utilize the sleep mode of inactivity. Subsequently, at time 2N, there may be another DRX cycle. This process may continue for any suitable amount of time until the sidelink connection is dropped, the UE transitions to a different operating mode or any appropriate condition triggers the UE to terminate sidelink DRX operations.

Those skilled in the art will understand that the sleep mode of inactivity does not necessarily mean putting the processor, the transmitter, and the receiver of the UE to sleep, in hibernation, or in deactivation. For example, the processor (e.g., baseband and/or application) may continue to execute other applications or processes. Instead, the sleep mode relates to conserving power by discontinuing a continuous processing functionality relating to operations that enable the UE to receive information and/or data over the sidelink. Any reference to the term DRX cycle is for illustrative purposes, different networks may refer to a similar concept by a different name. Further, reference to these cycles being configured in ms units is merely for illustrative purposes, the exemplary embodiments may utilize a DRX cycle that is based on subframes or any other suitable unit of time.

As mentioned above, the exemplary embodiments are directed towards implementing a sidelink DRX cycle. In one aspect, the exemplary embodiments include techniques for the UE to manage the sidelink DRX cycle. This may include techniques for operating one or more DRX timers that are configured to control various aspects of UE behavior with regard to data exchange processing. In another aspect, the exemplary embodiments relate to how the sidelink DRX cycle and other sidelink reception operations may influence sidelink transmission operations. The exemplary mechanisms described herein may be used in conjunction with currently implemented mechanisms related to sidelink DRX, future implementations of mechanisms related to sidelink DRX and independently from other mechanisms related to sidelink DRX.

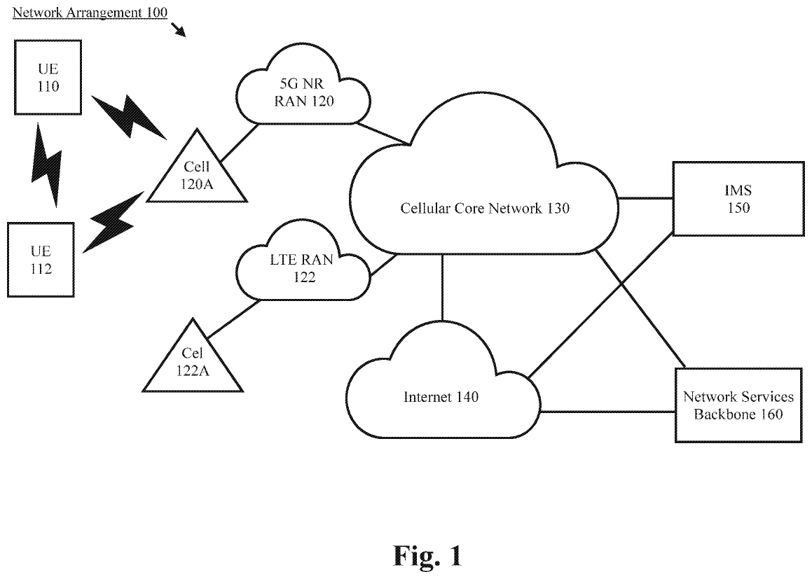

FIG. 1 shows an exemplary network arrangement 100 according to various exemplary embodiments. The exemplary network arrangement 100 includes UEs 110, 112. Those skilled in the art will understand that the UEs 110, 112 may be any type of electronic component that is configured to communicate via a network, e.g., a component of a connected car, a mobile phone, a tablet computer, a smartphone, a phablet, an embedded device, a wearable, an Internet of Things (IoT) device, etc. An actual network arrangement may include any number of UEs being used by any number of users. Thus, the example of two UEs 110, 112 is merely provided for illustrative purposes.

The UEs 110, 112 may communicate directly with one or more networks. In the example of the network configuration 100, the networks with which the UEs 110, 112 may wirelessly communicate are a 5G NR radio access network (5G NR-RAN) 120 and an LTE radio access network (LTE-RAN) 122. These types of networks support vehicle-to-everything (V2X) and/or sidelink communication. However, the UE 110 may also communicate with other types of networks that do not or do support V2X/sidelink (e.g., 5G cloud RAN, a next generation RAN (NG-RAN), a legacy cellular network, a WLAN, etc.) and the UEs 110, 112 may also communicate with networks over a wired connection. Therefore, the UEs 110, 112 may include a 5G NR chipset to communicate with the 5G NR-RAN 120 and an LTE chipset to communicate with the LTE-RAN 122.

The 5G NR-RAN 120 and the LTE-RAN 122 may be portions of cellular networks that may be deployed by cellular providers (e.g., Verizon, AT&T, T-Mobile, etc.). These networks 120, 122 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

The UEs 110, 112 may connect to the 5G NR RAN 120 via a cell 120A and the LTE RAN 122 via the cell 122A. The cells 120A, 122A may include one or more communication interfaces to exchange data and/or information with camped UEs, the RANs 120, 122, the cellular core network 130, the internet 140, etc. Further, the cells 120A, 122A may include a processor configured to perform various operations. For example, the processor may be configured to perform operations related sidelink DRX. These operations may include, but are not limited to, providing sidelink DRX configuration information to the UEs 110, 112 and scheduling sidelink resources. However, reference to a processor is merely provided for illustrative purposes. The operations of the cells 120A, 122A may also be represented as a separate incorporated component of the cell or may be a modular component coupled to the node, e.g., an integrated circuit with or without firmware. For example, the integrated circuit may include input circuitry to receive signals and processing circuitry to process the signals and other information. In addition, in some cells, the functionality of the processor is split among two or more processors such as a baseband processor and an applications processor. The exemplary embodiments may be implemented in any of these or other configurations of a cell.

Any suitable association procedure may be performed for the UEs 110, 122 to connect to the RANs 120, 122. An example of an association procedure is described below with regard to the UE 110 and the 5G NR RAN 120. As discussed above, the 5G NR RAN 120 may be associated with a particular cellular provider where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific cell or base station. Those skilled in the art will understand that similar procedures may be implemented for different types of networks.

The UEs 110, 112 may also communicate with one another directly using a sidelink. The sidelink is a direct D2D communication link. Thus, the information and/or data transmitted directly to the other endpoint (e.g., the UE 110 or the UE 112) does not go through a cell (e.g., gNB 120A, eNB 122A). In some embodiments the UEs 110, 112 may receive information from a cell regarding how the sidelink is to be established, maintained and/or utilized. Thus, a network (e.g., the 5G NR-RAN 120, LTE-RAN 122, etc.) may control the sidelink. In other embodiments, the UEs 110, 112 may control the sidelink. Regardless of how the sidelink is controlled, the UEs 110, 112 may maintain a downlink/uplink to a currently camped cell (e.g., cell 120A, cell 122A) and a sidelink to the other UE simultaneously.

The network arrangement 100 also includes a cellular core network 130, the Internet 140, an IP Multimedia Subsystem (IMS) 150, and a network services backbone 160. The cellular core network 130 may be considered to be the interconnected set of components that manages the operation and traffic of the cellular network. It may include the EPC and/or the 5GC. The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

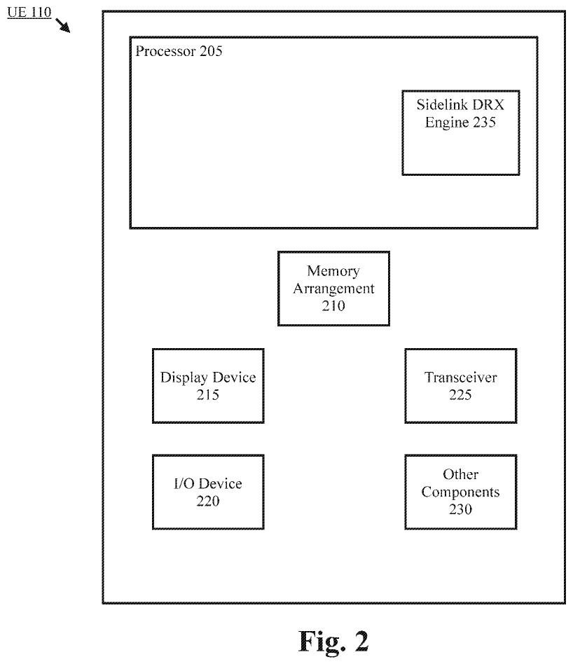

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 235 may include, for example, an audio input device, an audio output device, a power supply, a data acquisition device, ports to electrically connect the UE 110 to other electronic devices, etc. The UE 110 illustrated in FIG. 2 may also represent the UE 112.

The processor 205 may be configured to execute a plurality of engines of the UE 110. For example, the engines may include a sidelink DRX engine 235. The sidelink DRX engine 235 may perform operation related to managing a sidelink DRX cycle including, but not limited to, operating one or more DRX timers.

The above referenced engine 235 being an application (e.g., a program) executed by the processor 205 is only exemplary. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the UE 112, the 5G NR-RAN 120, the LTE-RAN 122, etc. Accordingly, the transceiver 225 may operate on a variety of different frequencies or channels (e.g., set of consecutive frequencies).

As mentioned above, the exemplary embodiments relate to implementing a sidelink DRX cycle. Sidelink communication may include the use of various different types of sidelink channels. Throughout this description, reference may be made to the physical sidelink control channel (PSCCH), the physical sidelink shared channel (PSSCH) and the physical sidelink feedback channel (PSFCH). The PSCCH may refer to a communication channel between a transmitting device (e.g., the UE 110) and the receiving device (e.g., the UE 112) that is configured to carry control information relevant to the sidelink. The PSSCH may refer to a communication channel between the transmitting device and the receiving device that is configured to carry payload data. The PSFCH may refer to a communication channel between the transmitting device and the receiving device that is configured to carry feedback relevant to the sidelink. The feedback may include HARQ feedback such as an acknowledgement (ACK) and a negative acknowledgement (NACK). However, any reference to these types of channels and messages is merely provided for illustrative purposes. Different entities may refer to similar concepts by a different name.

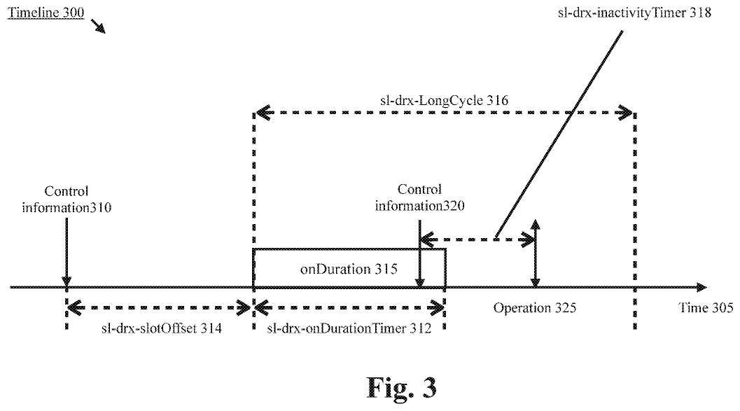

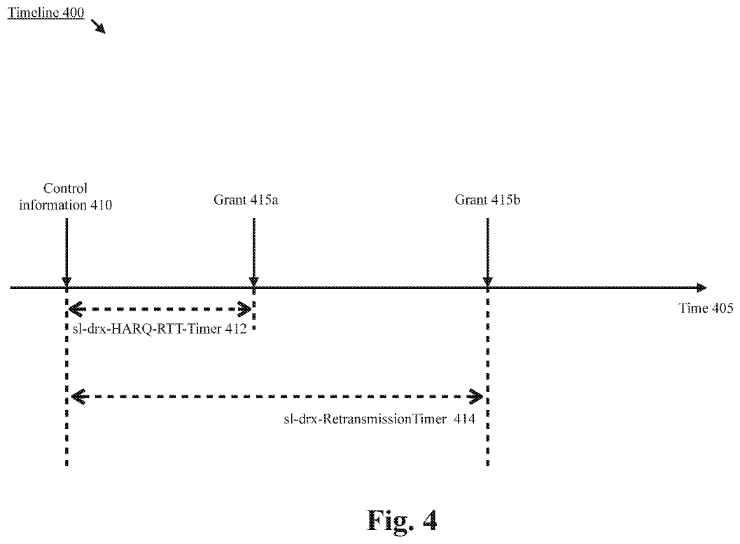

From the perspective of the UE 110, the sidelink DRX cycle may be implemented in accordance with its corresponding sidelink DRX configuration. Throughout this description, the term “sidelink DRX configuration” refers to a set of one of more parameters that enable the UE 110 to execute a sidelink DRX cycle. The set of parameters may include, but is not limited to, a “sidelink (sl)-drx-onDurationTimer,” a “sl-drx-slotOffset,” a “sl-drx-LongCycleStartOffset,” a “sl-drx-inactivityTimer,” a “sl-drx-hybrid automatic repeat request (HARQ)-round trip time (RTT)-Timer,” and a “sl-drx-RetransmissionTimer.” A brief description of each of these parameters will be provided below with regard to FIGS. 3-4. Additional details for each of these parameters are also provided after the description of FIGS. 3-4.

FIG. 3 shows a timeline 300 that represents UE 110 activity according to various exemplary embodiments. The timeline 300 will be used to provide context for the description of some of the sidelink DRX parameters mentioned above. However, any reference to a particular sidelink DRX parameter by a particular name is merely provided for illustrative purposes. Different networks may refer to similar concepts by different names.

The timeline 300 includes the time domain 305. In 310, the UE 110 may receive control information indicating that a sidelink DRX cycle is to be configured. This indication may be received from another UE (e.g., UE 112) via a sidelink or from a cell via a downlink. In addition, the control information may include sidelink DRX configuration information or the sidelink DRX configuration information may be provided in any other suitable manner.

In 315, an onDuration is scheduled. As indicated above, during the onDuration 315 the UE 110 may utilize an active mode of data exchange processing. Throughout this description, the term “sl-drx-onDurationTimer” refers to a timer that represents the duration at a beginning of a sidelink DRX cycle. In the example timeline 300, the duration of the sl-drx-onDurationTimer 312 is shown as coinciding with the scheduled onDuration 315. During operation, the status of the sl-drx-onDurationTimer 312 may indicate to the UE 110 whether the active mode of data exchange processing or the sleep mode of inactivity is to be utilized. This parameter may be set to a value expressed in 1/32 ms, ms or any other appropriate unit of time.

Throughout this description, the term “sl-drx-slotOffset” refers to a delay before starting the sl-drx-onDurationTimer. This parameter may be set to a value expressed in 1/32 ms or any other appropriate unit of time. To provide an example within the context of the timeline 300, the UE 110 may receive the control information 310 which triggers the UE 110 to initiate a sidelink DRX cycle. The sl-drx-slotOffset may indicate to the UE 110 the amount of the time the UE 110 is to wait before starting an onDuration 315 of the sidelink DRX cycle. Thus, the duration of the sl-drx-slotOffset 314 is shown as being in between the control information 310 and the onDuration 315.

Throughout this description, the term “sl-drx-LongCycleStartOffset” indicates both the long cycle length (e.g., sl-drx-LongCycle), and the sl-drx-slotOffset. In some embodiments, the UE 110 may be provided a variety of different choices of cycle length and offset. This parameter may be set to one or more values expressed in ms or any other appropriate unit of time. In the example of the timeline 300, the parameter sl-drx-LongCycle 316 is shown as representing the duration of the sidelink DRX cycle.

In some embodiments, the start condition of the sl-drx-onDurationTimer may be based on the following equation:

[(SFN*10)+subframe number]modulo(sl−drx−LongCycle)=sl−drx−StartOffset

The UE 110 may then wait an additional sl-drx-slotOffset at the beginning of the subframe that is to include the start of the sl-drx-onDurationTimer (if configured). Thus, sl-drx-slotOffset may be beneficial in scenarios where the sl-drx-onDurationTimer is less than 1 ms. Regarding a stop condition for the sl-drx-onDurationTimer, in some embodiments, the UE 110 may stop the sl-drx-onDurationTimer in response to receiving a MAC control element (CE) command from a cell regarding sidelink DRX operation. In other embodiments, the UE 110 may stop the sl-drx-onDurationTimer in response to receiving a MAC control element (CE) command from a further UE regarding sidelink DRX operation.

Returning to the example of the timeline 300, during the sl-drx-LongCycle 316, the UE 110 is configured to utilize the active mode of data exchange processing during the onDuration 315. During the sl-drxLongCycle 316 and outside of the onDuration 315, the UE 110 has the opportunity to enter the sleep mode of inactivity. However, as will be described in more detail below, there may be conditions that trigger the UE 110 to use the active mode of data exchange processing outside of the onDuration 310.

Throughout this description, the term “sl-drx-inactivityTimer” represents the duration after the PSCCH occasion in which a PSCCH indicates a new sidelink transmission for the corresponding sidelink transmission or reception activity. This mechanism may be used to trigger the UE 110 to use the active mode of data exchange processing within a sidelink DRX cycle but outside of the onDuration. To provide an example within the context of the timeline 300, in 320, the UE 110 may receive control information indicating a subsequent reception or transmission operation is to occur in 325. In the example of the timeline 300, the duration of the sl-drx-inactivtiyTimer 318 is shown as being in between the control information 320 and the operation 325.

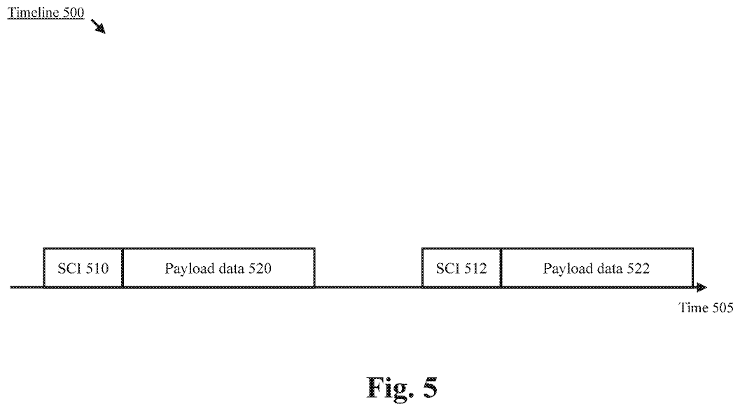

During operation, the status of the sl-drx-inactivityTimer may indicate to the UE 110 that the active mode of data exchange processing is to be utilized. Thus, in some embodiments, the UE 110 may use the active mode of data exchange processing based on the status of the sl-drx-inactivityTimer (e.g., running, expired, etc.). In the example of the timeline 300, the operation 325 is outside of the onDuration 315. Even outside of the onDuration 315, the active mode of data exchange processing may be used until the operation 325 is complete. Subsequently, if there is any time remaining in the sidelink DRX cycle, the UE 110 may use the sleep mode of inactivity. This parameter may be set to a value expressed in ms or any other appropriate unit of time. Additional details regarding the sl-drx-inactivityTimer handling will be provided below with regard to FIG. 5.

FIG. 4 shows a timeline 400 that represents the UE 110 activity according to various exemplary embodiments. The timeline 400 will be used to provide context for the description of some of the sidelink DRX parameters mentioned above. As mentioned above, any reference to a particular sidelink DRX parameter by a particular name is merely provided for illustrative purposes. Different networks may refer to similar concepts by different names.

The timeline 400 relates to the HARQ signaling. Those skilled in the art will understand that HARQ signaling refers to a signaling exchange in which a transmitting device transmits information and/or data to a receiving device. In response, the receiving device may transmit feedback (e.g., ACKs, NACKs, etc.) to the transmitting device. The feedback may trigger the transmitting device to retransmit some or all of the information and/or data to the receiving device. The timeline 400 is described with regard to the UE 110 as a receiving device.

The timeline 400 includes the time domain 405. In 410, the UE 110 receives control information. The control information may be sent by either a cell of the network over the downlink or the further UE over the sidelink.

In 415a, the UE 110 receives the sidelink HARQ retransmission grant. Throughout this description, the term “sl-drx-HARQ-RTT-Timer” represents the minimum duration before a sidelink HARQ retransmission grant is expected by the corresponding medium access control (MAC) entity. In the timeline 400, the duration of the sl-drx-HARQ-RTT-Timer 412 is shown as being in between the control information 410 and the grant 415a.

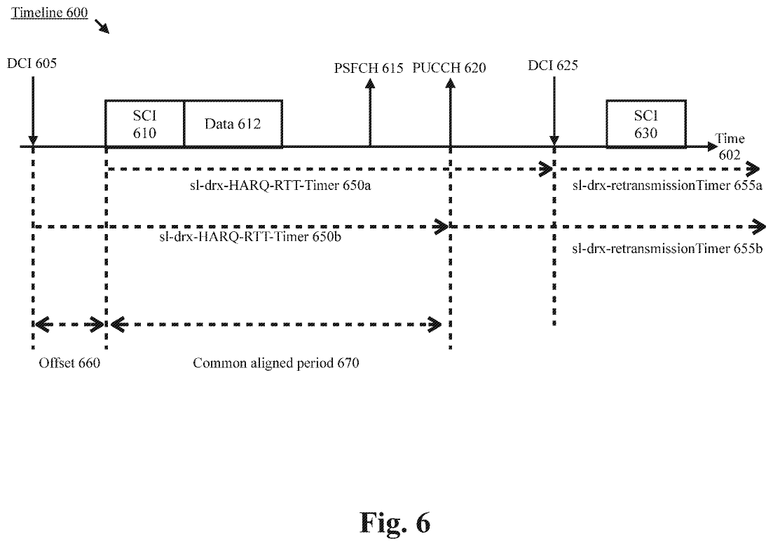

In 415b, the UE 110 receives the sidelink HARQ retransmission grant. The signals 415a and 415b are intended to represent two examples of receiving the same grant. Throughout this description, the term “sl-drx-RetransmissionTimer” represents the maximum duration until a sidelink HARQ retransmission grant is received or selected. In the timeline 400, the duration of the sl-drx-RetransmissionTimer 414 is shown as being in between the control information 410 and the grant 415b. Additional details regarding the sl-drx-HARQ-RTT-Timer and sl-drx-RetransmissionTimer are provided below with regard to FIG. 6.

The UE 110 may execute one or more sidelink DRX configurations. For example, in one embodiment, there is only one sidelink DRX configuration per sidelink MAC entity. In other embodiments, there may be sidelink DRX configurations per cast-type, per each peer UE, service type, per quality of service (QoS) or any combination thereof. In all of these examples, except for the per sidelink MAC entity option, the UE 110 may maintain and execute multiple different instances of sidelink DRX configurations at the same time.

For each sidelink DRX cycle a sidelink DRX Active time and a sidelink DRX Inactive time may be defined. During the DRX Active time, the UE 110 may use the active mode of data exchange processing with regard to the corresponding sidelink. During the DRX Inactive time, the UE 110 may conserve power by using the sleep mode of inactivity.

In one embodiment, the sidelink DRX Active time may occur when the sl-drx-onDurationTimer is running, the sl-drx-inactivityTimer is running, the sl-drx-retransmissionTimer is running or any other DRX timer when the sidelink DRX cycle is to be aligned with 5G NR interface (e.g., Uu) DRX operations. In this example, when any of the above referenced timers are not running, sidelink DRX Inactive time may occur.

In another embodiment, sidelink HARQ feedback may happen regardless of whether the UE 110 considers it to be sidelink DRX Active time or sidelink DRX Inactive time. Thus, the UE 110 may still be able to transmit or receive PSFCH over the sidelink during sidelink DRX Inactive time. Similarly, the UE 110 may still be able to transmit or receive PUCCH over the sidelink during sidelink DRX Inactive time. Accordingly, in some embodiments, DRX timers associated with sidelink HARQ feedback may not be considered when defining a sidelink DRX Active time and a sidelink DRX Inactive time.

In one embodiment, the transmission and reception of sidelink synchronization signals may occur independent of sidelink DRX Active time and sidelink DRX Inactive time. In another embodiment, if the UE 110 knows when the sidelink communication will occur the UE 110 can still receive PSCCH/PSFCH transmissions at that exact time instead of conducting power-consuming blind decoding of sidelink channels. Such an operation may be allowed even when the UE 110 is in sidelink DRX Inactive time.

In a further embodiment, a transmitting UE 110 does not start a new transport block in the sidelink HARQ process when the receiving UE is in the sidelink Inactive state. The examples provided above referenced the UE 110 performing operations outside of sidelink DRX Active time. In one aspect, this is because the sidelink DRX Active time is specific to a particular sidelink DRX cycle and does not consider other operations. In another aspect, the UE 110 may be able to perform operations outside of the sidelink DRX Active time using another power saving mechanism (e.g., wake-up signaling, power saving mode, etc.).

FIG. 5 shows a timeline 500 that represents sidelink activity according to various exemplary embodiments. The timeline 500 will be used to provide context for various techniques related to sl-drx-InactivityTimer handling.

The timeline 500 shows the time domain 505. In addition, the timeline 500 shows two instances of sidelink control information (SCI) 510, 512 and two instances of sidelink payload data 520, 522.

During operation, in some embodiments, the UE 110 may start or restart the sl-drx-inactivityTimer when the UE 110 receives a PSCCH matching a layer 1 (L1) ID of the receiving UE 110 interests. In another embodiment, the UE 110 may start or restart the sl-drx-InactivityTimer when the UE 110 determines that a layer 2 (L2) ID decoded in the PSCCH matches the UE 110. In a further embodiment, the UE 110 may start the sl-drx-inactivityTimer initially based on the L2 ID as this is a new transmission (e.g., new data indicator (NDI) is toggled in SCI 510) and during operation, start or restart of the sl-drx-inactivityTimer based on the L1 ID matching if this is a retransmission (e.g., NDI is not toggled in SCI 512). The UE 110 may use any of the above reference options or any other suitable condition to trigger the start or restart of the sl-drx-inactivityTimer.

There are a variety of different factors to consider when determining the duration of time the sl-drx-inactivityTimer is to cover. As mentioned above, when the sl-drx-InactivityTimer is running the UE 110 may utilize an active mode of data exchange processing.

In one embodiment, the duration of the sl-drx-inactivityTimer should be long enough to cover the time spent for the worst-case scheduling of a next retransmission. To account for this, the minimum sl-drx-inactivityTimer setting covers the gap between the PSFCH and the next sidelink retransmission or transmission. For example, the sl-drx-inactivityTimer is set to at least (x) ms to cover the worst case scheduling scenario so any retransmission will automatically extend the sl-drx-inactivityTimer by (x) ms. In the timeline 500, the duration of the sl-drx-inactivityTimer covers the time between the reception of the payload data 520 and the reception of the SCI 512. Thus, the UE 110 may use the active mode of data exchange processing from the beginning of the SCI 510 to the end of payload data 522 even though there is no information or data to receive in between the data 520 and the SCI 512.

In another embodiment, for each HARQ process, the UE 110 may skip monitoring the PSCCH between transmissions. For example, SCI 510 may indicate the offset for the next transmission slot for this HARQ process, e.g., the time location of SCI 512. Since the UE 110 knows when the next SCI is scheduled to occur, the UE 110 may omit using the sl-drx-inactivityTimer or may ensure that the duration of the sl-drx-inactivityTimer does not exceed the payload data 520. In this example, in between the payload data 520 and the SCI 512, the UE 110 may use the sleep mode of inactivity. Thus, this embodiment may provide power saving benefits when compared to the embodiment described above.

The following exemplary embodiments will be described with regard to mode 1 and mode 2 sidelink scheduling. These modes may be defined in the third generation partnership (3GPP) release 16. Those skilled in the art will understand that mode 1 refers a scheme in which the serving cell assigns or controls the sidelink resources. Mode 2 refers to a scheme in which the transmitting UE self-selects the sidelink resources according to various collision avoidance rules.

As specified in 3GPP Rel-16, for regular mode 1 or mode 2, there is no need to use RTT timers for the execution of a sidelink DRX cycle. This is because the gaps between two consecutive transmissions is not static and cannot be regulated with a fixed configured value. In addition, the UE 110 may determine the next slot where PSCCH for retransmission is scheduled and skip decoding until that time for this sidelink HARQ process. However, in some scenarios, the offset of the next retransmission may not be included in SCI because the cell or the UE 110 may be unable to reserve sidelink radio resources for the retransmission beforehand due to limited sidelink resource availability.

For mode 2 enhancement cases (e.g., inter-UE coordination mode 2b or mode 2d of 3GPP release 17), a retransmission may be dynamically scheduled by a peer UE. This feature may introduce some uncertainty with regard to sidelink scheduling for retransmission. Thus, this feature may be considered for sidelink DRX configuration.

For instance, due to scheduling uncertainty associated with mode 2 enhancement cases (and regular cases), the retransmission offset may be absent in SCI. To account for this the sidelink DRX configuration parameters described with regard to FIG. 4 may be used. In this configuration, the UE 110 only restarts the sl-drx-inactivityTimer in response to decoding a first initial transmission of a transport block. The UE 110 may also start the sl-drx-HARQ-RTT-Timer in response to the decoding. The sl-drx-HARQ-RTT-Timer at least covers the decoding delay and PSFCH transmission. For any retransmission, the sl-drx-inactivityTimer is not restarted. When the sl-drx-HARQ-RTT-Timer expires for a sidelink HARQ process, the sl-drx-retransmissionTimer is started for this sidelink HARQ process. If the UE 110 successfully decodes the transport block, the UE 110 may stop the sl-drx-HARQ-RTT-Timer or let it expire without triggering the start of the retransmission timer.

It may be beneficial for the DRX configuration to apply to both transmission and reception operations for the sidelink. To provide an example, for mode 2, a transmitting UE conducts sensing and congestion control measurements which rely on reception operations. For mode 1, the UE 110 may monitor PDCCH for SL grants and both Uu and sidelink DRX configuration are to be aligned. To provide another example, two UEs in peer-to-peer PC5 interface link may be on and off in sync. Those skilled in the art will understand that the PC5 interface is the direct interface between UEs. For at least the reasons provided above, it may be beneficial for the DRX configuration to apply to both transmission and reception operations for the sidelink. The following exemplary embodiments relate to the relationship between a sidelink DRX configuration and sidelink transmission operations.

In some embodiments, the UE 110 may not be configured to perform a sidelink transmission during sidelink DRX Inactive time. In other embodiments, the UE 110 may start or restart the sl-drx-inactivityTimer when the UE 110 transmits PSCCH or PSSCH except for the case where a sl-drx-RetransmissionTimer is used by the UE 110.

For mode 2 configuration, in some embodiments, the sidelink DRC configuration includes an sl-drx-onDurationTimer that is aligned with the UE 110 transmitting schedule. In other embodiments, a mode 2 UE does not initiate a new transport block for sidelink HARQ process in its own sidelink DRX Inactive time. In further embodiments, the mode 2 UE 110 is configured to finish an ongoing HARQ process without using the sl-drx-HARQ-RTT-Timer or the sl-drx-retransmissionTimer. In still other embodiments, if the selected resource corresponds to a sidelink DRX Inactive time, the mode 2 UE skips the sidelink transmission or retransmission. This may cause the resource selection mechanism to avoid scheduling transmissions during the sidelink DRX Inactive time.

FIG. 6 shows a timeline 600 that represents UE 110 activity according to various exemplary embodiments. The timeline 600 describes embodiments sidelink DRX timers that consider mode 1 related aspects. For mode 1 sidelink operation, a transmitting UE gets the sidelink grants from the serving cell. Thus, the UE 110 may be involved in both Uu communication and sidelink communication.

Consider the following exemplary configuration for the UE 110. During operation, if the cell schedules the sidelink grant (e.g., time and location of the sidelink resource for SCI transmission) during sidelink DRX Inactive time, the UE 110 still performs the sidelink transmission. Thus, the cell scheduling via DCI may override the sidelink DRX configuration.

The timeline 600 include the time domain 602. In 605, the UE 110 receives downlink control information (DCI). This dynamic grant (DG) DCI may schedule sidelink control information and trigger the UE 110 to initiate a sidelink DRX cycle.

In 610, the UE 110 receives SCI. In 612, the UE 110 receives payload data. In 615, the UE 110 may transmit over the PSFCH. In 620, the UE 110 may transmit over the PUCCH. In 625, the UE 110 receives DCI. In 630, the UE 110 may receive SCI. These events will be used to provide context to the different embodiments described below.

In some embodiments, the sl-drx-HARQ-RTT-Timer and the sl-drx-retransmissionTimer start and stop in accordance with sidelink operations. For example, the sl-drx-HARQ-RTT-Timer may start at the reception of PSCCH (e.g., SCI 610). An example of the duration of this timer is shown on the timeline 600 by the duration 650a. The sl-drx-retransmissionTimer may start at the reception of the sidelink grant in PDCCH (e.g., DCI 625). An example of the duration of this timer is shown on the timeline 600 by the duration 655a. In another embodiment, the sl-drx-retransmissionTimer may start when the sl-drx-HARQ-RTT-Timer expires. In this example, the sl-drx-HARQ-RTT-Timer value cannot be longer than the expected sidelink grant allocation time for HARQ retransmission.

In other embodiments, the sidelink related timers may be incorporated into Uu DRX operations. For example, the sl-drx-HARQ-RTT-Timer may start at the same time as the corresponding Uu timer. Thus, the sl-drx-HARQ-RTT-Timer may start at the reception of DCI 605. An example of the duration of this timer is shown on the timeline 600 by the duration 650b. Similarly, the sl-drx-retransmissionTimer may start at the reception of the DCI 625. An example of the duration of this timer is shown on the timeline 600 by the duration 655b.

In other embodiments, the staggering of sidelink to Uu may be configured with a fixed offset (e.g., offset 660). This offset may account for the gap between DCI and SCI reception. The sidelink DRX timers may then be aligned with the Uu DRX timers by setting the sidelink DRX timers to a value that is based on the status of the Uu DRX timers. This common aligned period is shown in the timeline 600 by the duration 670.

In some embodiments, the alignment of Uu DRX and sidelink DRX interfaces may happen between two UEs engaged in sidelink communication. To provide and example, a first UE may be configured with Uu DRX timers for HARQ RTT and retransmission. Based on those timer values, the first UE may derive the values for sl-drx-HARQ-RTT-Timer and sl-drx-retransmissionTimers to be used by their peer UE and send those values with either a PC5-RRC message or a sidelink MAC CE to the peer UE. The peer UE may then incorporate those values into a sidelink DRX configuration to align the Uu DRX and sidelink DRX interfaces.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. A processor of a user equipment (UE) configured to perform operations comprising:
establishing a sidelink with a further UE;
configuring a sidelink discontinuous reception (DRX) cycle;
receiving first sidelink control information (SCI) and first data at a first time during the sidelink DRX cycle; and
receiving second SCI at a second time during the sidelink DRX cycle.

2. The processor of claim 1, wherein the first SCI indicates an offset relative to the second SCI and wherein the UE uses a sleep mode of inactivity with regard to data exchange processing during a time gap between the first data and the second SCI.

3. The processor of claim 2, wherein the UE transitions from the sleep mode of inactivity to an active mode of data exchange processing to receive the second SCI based on a value of the offset.

4. The processor of claim 1, wherein the UE is configured to start or restart a sidelink DRX inactivity timer in response to physical sidelink control channel (PSCCH) that includes a layer 1 (L1) ID matching a set of L1 IDs representing the UE interests.

5. The processor of claim 1, wherein the UE is configured to start or restart a sidelink DRX inactivity timer in response to physical sidelink control channel (PSCCH) that includes a layer 2 (L2) ID that matches an L2 ID associated with the UE.

6. The processor of claim 1, wherein the UE is configured to i) start or restart a sidelink DRX inactivity timer in response to physical sidelink control channel (PSCCH) that includes a layer 1 (L1) ID matching a set of L1 IDs representing the UE interests when the first SCI indicates a HARQ retransmission and ii) start or restart the sidelink DRX inactivity timer in response to PSCCH that include a layer 2 (L2) ID that matches an L2 ID associated with the UE when the first SCI indicates a new transmission.

7. The processor of claim 1, wherein the UE is configured to start or restart a sidelink DRX inactivity timer based on UE transmission activity.

8. The processor of claim 1, wherein the UE is configured to start a sidelink DRX hybrid automatic repeat request (HARQ) round trip time (RTT) timer in response to receiving the first SCI.

9. The processor of claim 1, wherein the UE is configured to start a sidelink DRX retransmission timer in response to receiving downlink control information (DCI) from a serving cell.

10. The processor of claim 1, wherein the UE is configured to start a sidelink DRX retransmission timer after a sidelink DRX HARQ round trip timer (RTT) timer expires.

11. The processor of claim 1, wherein the UE is configured to start i) a sidelink DRX hybrid automatic repeat request (HARQ) round trip time (RTT) timer and ii) a DRX HARQ RTT timer for DRX operations corresponding to a Uu interface in response to receiving downlink control information (DCI) from a serving cell.

12. The processor of claim 1, wherein the UE is configured to start i) a sidelink DRX retransmission timer and ii) a DRX retransmission timer for DRX operations corresponding to a Uu interface in response to transmitting physical uplink control channel (PUCCH) to a serving cell.

13. The processor of claim 1, wherein the UE is configured to align, using an offset, a sidelink DRX hybrid automatic repeat request (HARQ) round trip time (RTT) timer and a DRX HARQ RTT timer for DRX operations corresponding to a Uu interface.

14. The processor of claim 1, wherein the UE configures a peer UE with a sidelink DRX HARQ round trip time (RTT) timer and a sidelink DRX retransmission timer based on the configured DRX HARQ RTT timer and DRX retransmission timer for DRX operations corresponding to a Uu interface.

15. The processor of claim 1, wherein the UE is configured to use an active mode of data exchange processing during the DRX cycle when i) a sidelink DRX onDuration timer is running, ii) a sidelink DRX inactivity timer is running or iii) a sidelink DRX retransmission timer is running.

16. The processor of claim 1, wherein the UE operates a sidelink DRX onDuration timer that represents a duration at a beginning of the DRX cycle.

17. The processor of claim 1, wherein the UE operates a sidelink DRX inactivity timer that represents a duration after a physical sidelink control channel (PSCCH) occasion in which a PSCCH indicates a new sidelink transmission for a corresponding sidelink transmission or reception activity.

18. A user equipment (UE) including:
a transceiver configured to communicate via a sidelink; and
a processor communicatively coupled to the transceiver, the processor configured to perform operations comprising:
configuring a sidelink discontinuous reception (DRX) cycle;
utilizing an active mode of data exchange processing during an onDuration of the sidelink DRX cycle; and
utilizing a sleep mode of inactivity outside of the onDuration of the sidelink DRX cycle.

19. The UE of claim 18, wherein the UE operates a sidelink DRX onDuration timer that represents a duration at a beginning of the DRX cycle.

20. The UE of claim 18, wherein the UE operates a sidelink DRX inactivity timer that represents a duration after a physical sidelink control channel (PSCCH) occasion in which a PSCCH indicates a new sidelink transmission for a corresponding sidelink transmission or reception activity.

21-26. (canceled)
